(19) United States
(12) Patent Application Publication
(10) Pub. No.: US 2014/0156553 A1
(43) Pub. Date: Jun. 5, 2014

(54) Systems and Methods for Fulfilling Orders

(71) Applicant: LIGHTSPEED AUTOMATION LLC, Suwannee, GA (US)

(72) Inventors: Jason Leach, Johns Creek, GA (US); Randy Smith, Alpharetta, GA (US)

(73) Assignee: LIGHTSPEED AUTOMATION LLC, Suwannee, GA (US)

(21) Appl. No.: 13/689,908

(22) Filed: Nov. 30, 2012

(51) Int. Cl. G06Q 10/08

(52) U.S. Cl. CPC G06Q 10/08355
USPC 705/338; 705/337

(57) ABSTRACT

Various embodiments for facilitating the fulfillment of orders are disclosed. One embodiment is a method implemented in at least one computing device for fulfilling an order for an item in a storage facility. The method comprises obtaining an order for the item from a third party order provider, converting the order to a predetermined format for fulfillment, generating guidance information based on the converted order and at least one attribute of the item, and transmitting the guidance information to a wireless computing device for fulfillment of the order by a picker.

### TECHNICAL FIELD

The present disclosure generally relates to fulfilling item orders and more particularly, to systems and methods for fulfilling orders via mobile computing devices in facilities with computer-directed product picking capabilities.

### BACKGROUND

Order fulfillment is a critical supply chain element in many industries. Typically, an internal or external customer initiates a request for one or more items from a supplier who must then deliver the requested items in return. Many times, suppliers face time constraints, delivery issues, and other logistical issues in delivering the items to the customer. Many fulfillment centers pick and deliver items via paper-based processes where paper slips are used by pickers to locate items within a storage facility. From a high level, a designated picker attempts to locate the items listed on the paper order and then takes the retrieved items to a fulfillment area. Such methods, however, tend to be both time consuming and prone to error.

Other systems may utilize light-emitting diode (LED) indicators distributed throughout the storage facility/fulfillment area where every item is identified by a light. Typically, the quantity specified in the order is also displayed. While such systems tend to speed up the fulfillment process, these systems tend to be very expensive to implement, and such systems tend to work poorly in some scenarios. For example, when the ratio of items in a warehouse to items on an order is very high, it becomes as cumbersome to look for the LED indicators as it is to search for the product without the assistance of the LED indicators.

### SUMMARY

Briefly described, one embodiment, among others, is a method implemented in at least one computing device for fulfilling an order for an item in a storage facility. The method comprises obtaining an order for the item from a third party order provider, converting the order to a predetermined format for fulfillment, generating guidance information based on the converted order and at least one attribute of the item, and transmitting the guidance information to a wireless computing device for fulfillment of the order by a picker.

Another embodiment is a system for fulfilling an order for an item in a storage facility. The system comprises a third party interface configured to obtain an order for the item from a third party order provider and an item retriever configured to obtain data corresponding to the item from a database, wherein the item retriever is further configured to convert the order to a predetermined format for fulfillment according to the data retrieved from the database, and generate guidance information based on the converted order and at least one attribute of the item. The system further comprises a content server configured to transmit the guidance information to a wireless computing device for fulfillment of the order by a picker.

Another embodiment is a non-transitory computer-readable medium embodying a program executable in a mobile computing device, where the program comprises code that transmits a current location of the mobile computing device to an order fulfillment server and code that obtains guidance information from the order fulfillment server for picking a plurality of units of an item, wherein the guidance information is generated based on an order for the item from at least one third party order provider. The program further comprises code that encodes for display a user interface based on the guidance information and code that transmits an acknowledgement upon retrieving the item.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a networked environment in which an order fulfillment server may be implemented for facilitating fulfillment of orders in accordance with various embodiments of the present disclosure.

FIG. 2 is a top-level flowchart illustrating examples of functionality implemented as portions of the order fulfillment server of FIG. 1 for facilitating the retrieval of items in accordance with various embodiments of the present disclosure.

FIGS. 3-5 provide illustrations of how guidance information may be generated by the order fulfillment server of FIG. 1 based on item attributes and then routed to various pickers in accordance with various embodiments of the present disclosure.

FIG. 6 is a schematic block diagram of the order fulfillment server of

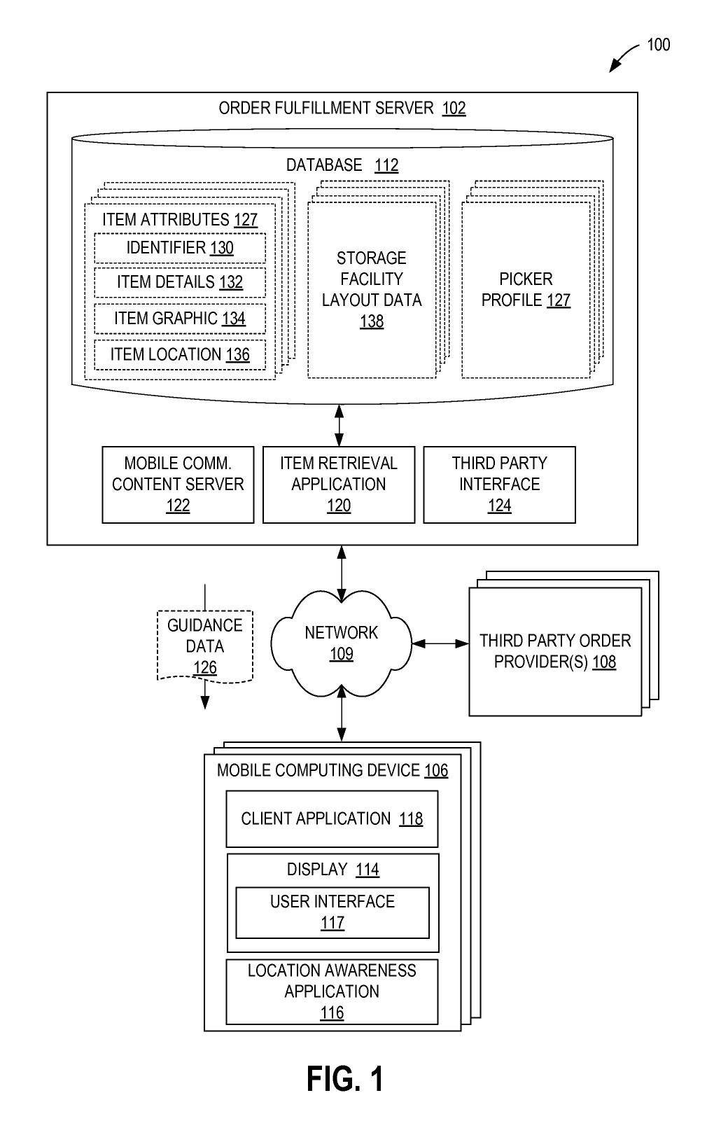

FIG. 1 in accordance with various embodiments of the present disclosure.

FIG. 7 is a schematic block diagram of the mobile computing device of FIG. 1 in accordance with various embodiments of the present disclosure.

### DETAILED DESCRIPTION

Various embodiments are disclosed for facilitating the fulfillment of orders generated by third party order providers where orders may be obtained for various items from multiple order providers. In accordance with various embodiments, the orders are consolidated and converted into a format compatible with the system disclosed. Guidance information is generated based on the converted order and one or more attributes of the item. The generated guidance information is then transmitted to a picker equipped with a wireless computing device for fulfilling the order. For some embodiments, the guidance information routes the picker according to the most advantageous path through the storage facility for retrieving one or more items. The orders obtained from the third party order providers may be distributed or grouped according to geocentric or product-centric pick zones for fulfillment by one or more pickers

A description of a system for fulfilling orders is now described followed by a discussion of the operation of the components within the system. FIG. 1 is a block diagram of an order fulfillment server 102 operating in a networked environment 100 in which embodiments of the item retrieval techniques disclosed herein may be implemented. The order fulfillment server 102 is communicatively coupled via a network 109 to one or more mobile computing devices 106 and one or more third party order providers 108. The network 109 may include, for example, the Internet, intranets, extranets, wide area networks (WANs), local area networks (LANs), wired networks, wireless networks, or other suitable networks, etc., or any combination of two or more such networks.

The order fulfillment server 102 may be embodied, for example, as a server computer or any other system providing computing capability. Note that while the order fulfillment server 102 is referred to herein in the singular, it is understood that the order fulfillment server 102 may comprise a plurality of servers. For various embodiments, the order fulfillment server 102 is implemented on a client-server architecture using a combination of web services based on SOAP (Simple Object Access Protocol) and WCF (Windows Communication Foundation) protocols.

Various applications may be executed in the order fulfillment server 102 according to various embodiments. Also, various data is stored in a database 112 that is accessible to the order fulfillment server 102, where the database 112 may be embodied as a client-server based relational database built on a Microsoft® SQL Server architecture. For various embodiments, the database 112 may be configured to support Transact-SQL based queries, functions, procedures, triggers, and data management objects to store, retrieve, sort, report and manipulate all the data used by the order fulfillment server 102. The database 112 may be representative of a plurality of databases as can be appreciated, and the data stored in the database 112 is associated with the operation of the various applications and/or functional entities described below.

The components executed on the order fulfillment server 102 include an item retrieval application 120, a mobile communication content server 122, and a third party interface 124. The order fulfillment server 102 may include other applications, services, processes, systems, engines, or functionality not discussed in detail herein.

The item retrieval application 120 is executed to facilitate the retrieval of items from one or more storage facilities. For some embodiments, the item retrieval application 120 converts orders obtained from third party order providers 108 into a format compatible with the order fulfillment server 102. For some embodiments, the orders are obtained by the order fulfillment server 102 via a third party interface 124, which enables data communication between the order fulfillment server 102 and third party order providers 108.

For some embodiments, the third party interface 124 is a Windows Communication Foundation (WCF) based interface utilized to obtain orders from various third party order providers 108. The third party interface 124 may be utilized by the item retrieval application 120 to obtain information from source orders and to provide picking feedback to the originating third party order provider 108. Orders may be obtained from third party order providers 108 through a variety of mechanisms including, for example, web services, direct database access, text file transfers, and other means.

Based on the converted order and based on one or more attributes of the item being ordered, the item retrieval application 120 generates guidance data 126, which is then transmitted via the mobile communication content server 122 to a mobile computing device 106 corresponding to a picker located at a storage facility. The mobile communication content server 122 may be embodied as a SOAP-based server that supports all communication with a client application 118 executing on mobile computing devices 106 utilized by pickers.

The mobile communication content server 122 may support various commands that are enacted remotely by the client application 118 and return data and/or result sets to the mobile computing device 106 and perform actions on the database 112. The mobile communication content server 122 may operate in conjunction with the item retrieval application 120 and the third party interface 124 to forward requests/results to third party order providers 108. For some embodiments, the mobile communication content server 122 may support an ADO-based interface with the SQL Server database 112 for data access.

The data stored in the database 112 may comprise one or more sets of item attributes 127 that include such information as item identifiers 130 (e.g., “Model XYZ DSLR Digital Camera”), item details 132 (e.g., description, weight, size), an item graphic 134 (e.g., a photograph of the item), item location 136 (e.g., the storage facility in which the item is stored), and so on. The database 112 may also store layout data 138 corresponding to various storage facilities in which items are stored. Such layout data 138 may be utilized by the item retrieval application 120 to generate routing instructions for purposes of navigating a picker through the most optimum path in retrieving one or more items. The database 112 may further store profile data 127 associated with pickers. Associated with each picker profile 127, for example, is various data corresponding to a respective picker such as the current status of the picker (e.g., busy retrieving items for an existing order), the storage facility in which the picker is stationed at, and so on.

The mobile computing device 106 is representative of mobile computing devices used by pickers and are coupled via the network 109 to the order fulfillment server 102. The mobile computing device 106 may comprise, for example, a processor-based system such as a computer system. Such a computer system may be embodied in the form of a tablet computer system, a smartphone, a personal digital assistant, or other mobile devices with wireless communication capabilities.

The mobile computing device 106 may include a display 114, where the display may comprise, for example, one or more devices such as a touchscreen display. The mobile computing device 106 may further comprise a global positioning system (GPS) device configured to determine a current location of the mobile computing device 106. A location awareness application 116 executing on the mobile computing device 106 may operate in conjunction with the GPS device to provide the current location of the mobile computing device 106 to the order fulfillment server 102.

The mobile computing device 106 may be configured to execute additional applications such as a client application 118 and/or other applications, where the client application 118 may be executed to access and render for display the guidance data 126 generated by the item retrieval application 120 in the order fulfillment server 102. The guidance data 126 may be presented to the picker in the form of a user interface 117. The client application 118 may also be executed to transmit an acknowledgement to the order fulfillment server 102 confirming that the picker has retrieved the one or more items assigned to the picker.

For some embodiments, the client application 118 may be configured to direct a picker to fulfill multiple orders simultaneously. The client application 118 may be configured to select individual items in the order sorted by, for example, the shortest walking distance in the storage facility, and direct the picker to the item. The client application 118 presents the quantity of the item required for each of the orders being fulfilled. The picker may utilize a touchscreen display or other means to provide feedback to the order fulfillment server 102 that the item has been picked.

The item(s) to be picked may be identified by name, code, location, a photograph, and so on. For some embodiments, the mobile computing device 106 may be configured to support item identification through a barcode reader. An order on the mobile computing device 106 may represent a portion of an original order as external orders may be broken up by geography or by pick process into multiple orders to be picked by multiple pickers.

Note that another method of distributing items using the mobile computing device 106 comprises taking orders and grouping them by individual item. This allows a single item to be distributed among a set of orders grouped by, for example, the truck or distribution channel. In this regard, rather than “picking” an item, an item may undergo a “putting” process as the single item is distributed across multiple orders.

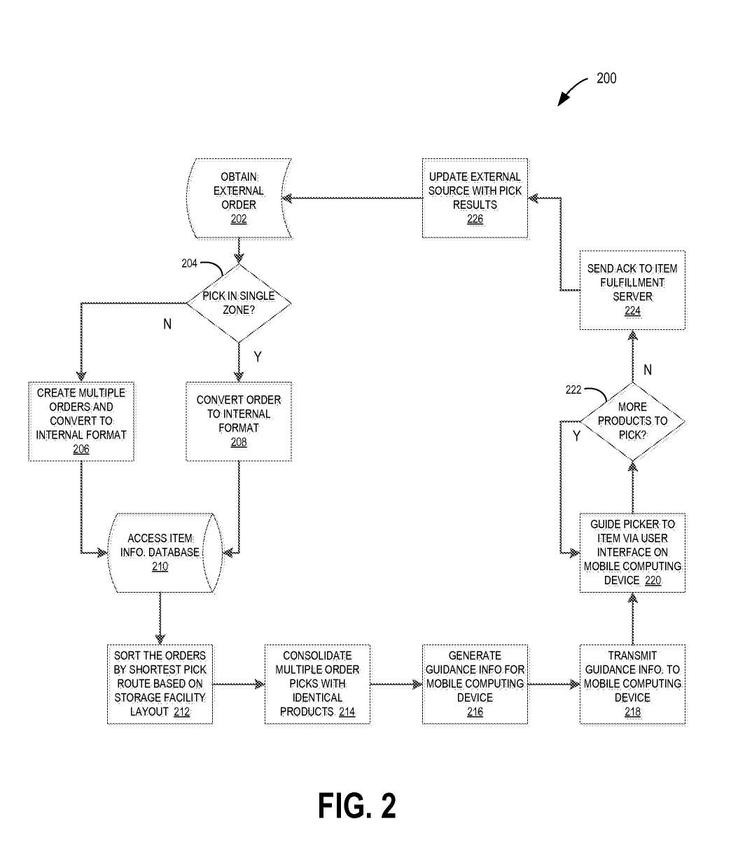

Reference is made to FIG. 2, which is a flowchart 200 in accordance with one embodiment for facilitating order fulfillment by the order fulfillment server 102 of FIG. 1. It is understood that the flowchart 200 of FIG. 2 provides merely an example of the many different types of functional arrangements that may be employed to implement operation of the various components of the order fulfillment server 102 (FIG. 1). As an alternative, the flowchart of FIG. 2 may be viewed as depicting an example of steps of a method implemented in the order fulfillment server 102 according to one or more embodiments.

Although the flowchart of FIG. 2 shows a specific order of execution, it is understood that the order of execution may differ from that which is depicted. For example, the order of execution of two or more blocks may be scrambled relative to the order shown. Also, two or more blocks shown in succession in FIG. 2 may be executed concurrently or with partial concurrence. It is understood that all such variations are within the scope of the present disclosure.

Beginning with block 202, an order is obtained from a third party order provider 108 (FIG. 1), and in block 204 a determination is made by the item retrieval application 120 (FIG. 1) whether the items in the order are located in a single zone within a storage facility. In block 208, if the items are all located within a single zone, the order is converted to a format that is compatible with the order fulfillment sever 102. In block 206, if the items are not located within a single zone, the original order may be divided into multiple orders, which may then be assigned to multiple pickers.

In block 210, the item retrieval application 120 accesses the database 112 (FIG. 1) to retrieve additional information relating to the item. As discussed earlier, the database 112 may store such item attributes 127 as an item identifier 130 (FIG. 1); item details 132 (FIG. 1) such as description, weight, size; an item graphic 134 (FIG. 1) such as a photograph of the item; the item location 136 (FIG. 1), and so on.

The item retrieval application 120 may also retrieve layout data 138 (FIG. 1) corresponding to various storage facilities in which items are stored. Such layout data 138 may be utilized by the item retrieval application 120 to generate routing instructions for purposes of navigating a picker through the most optimum path in retrieving one or more items.

In block 212, the item retrieval application 120 sorts the order by the shortest pick route based on the storage facility layout data 138 retrieved by the item retrieval application 120. In block 214, the item retrieval application 120 consolidates multiple order picks that correspond to the same item. For example, multiple orders might specify the same camera model. In this scenario, the item retrieval application 120 consolidates the multiple orders such that a single picker retrieves the cameras to fulfill the multiple orders.

In block 216, the item retrieval application 120 generates guidance information based on the converted orders and one or more attributes corresponding to the items. In block 218, the guidance information 218 is transmitted to the appropriate mobile computing device 106 (FIG. 1). For example, the item retrieval application 120 transmits the guidance information to a picker stationed at the storage facility in which an order item is located.

In block 220, the client application 118 (FIG. 1) executing on the mobile computing device 106 guides the picker via a user interface 117 (FIG. 1) shown on the display 114 (FIG. 1) of the mobile computing device 106. The picker retrieves the items until no more items are left to be retrieved (block 222).

In block 224, once all the items assigned to the picker have been retrieved, the picker sends an acknowledgement via the mobile computing device 106 to the order fulfillment server 102. In block 226, the item retrieval application 120 notifies the third party order provider 108 that generated the order that the item has been retrieved and shipped to the customer.

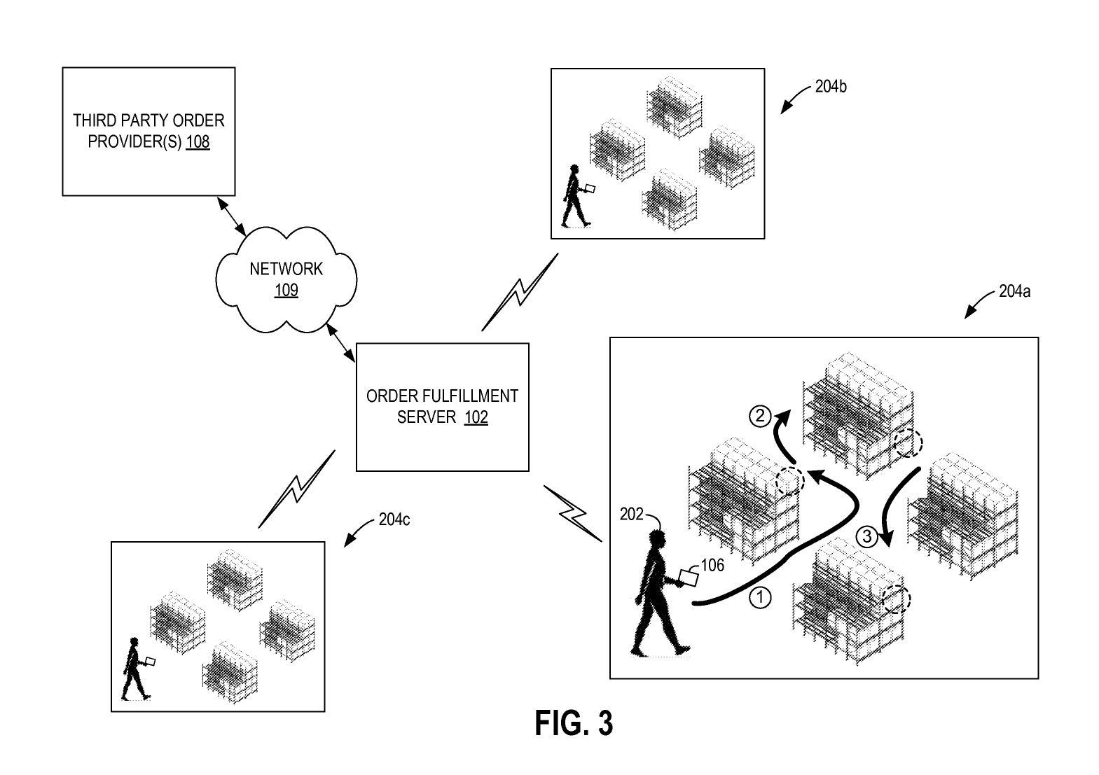

To further illustrate the fulfillment technique disclosed, reference is made to FIG. 3, which illustrates the order fulfillment server 102 communicatively coupled to various mobile computing devices 106 located at various storage facilities 204a, 204b, 204c. As described above and as shown in FIG. 3, the order fulfillment server 102 obtains orders from third party order providers 108 via a network 109. Based on attributes of the items specified in the orders, the order fulfillment server 102 generates guidance data 126 (FIG. 1) and routes the guidance data 126 to the appropriate picker 202.

In the example shown, a picker 202 at storage facility 204a is assigned multiple items to retrieve. The mobile computing device 106 receives the guidance data generated by the order fulfillment server 102 and provides step-by-step directions to the picker 202 based on the most optimum route determined by the order fulfillment server 102. In this regard, various functions performed by the order fulfillment server 102 may alternatively be performed by the mobile computing device 106 or distributed across both entities.

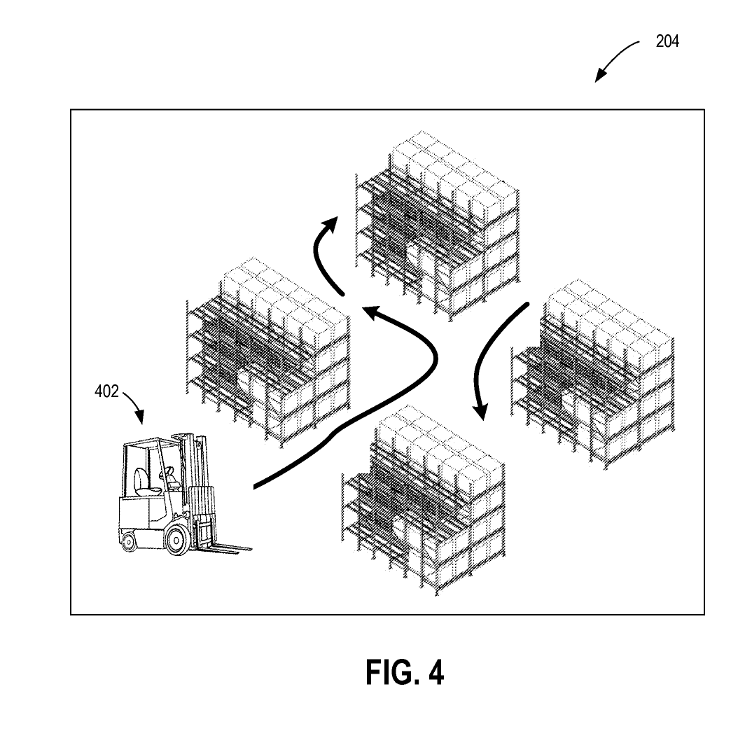

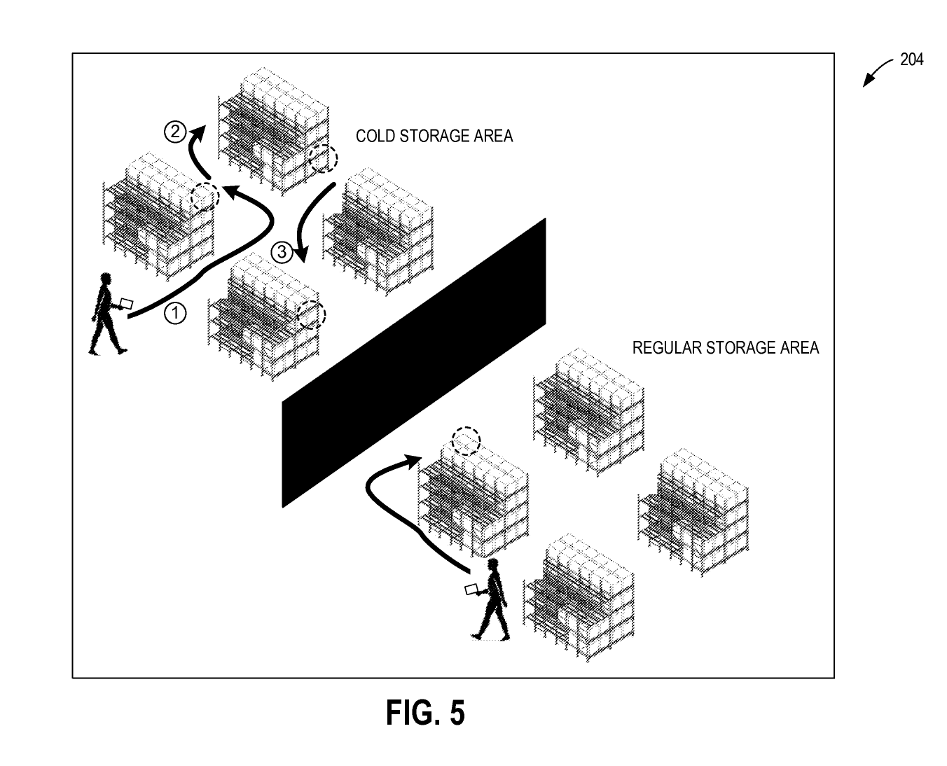

With reference to FIG. 4, the guidance data 126 (FIG. 1) may be generated based on the means of handling required to retrieve the item. In the example shown, the particular item(s) to be retrieved requires a forklift 402 to aid in the retrieval process. FIG. 5 illustrates another scenario in which certain items may require refrigerated storage. Thus, while a list of items may be physically located within the same storage facility, the item retrieval application 120 (FIG. 1) may nevertheless determine that multiple pickers are needed to retrieve the items.

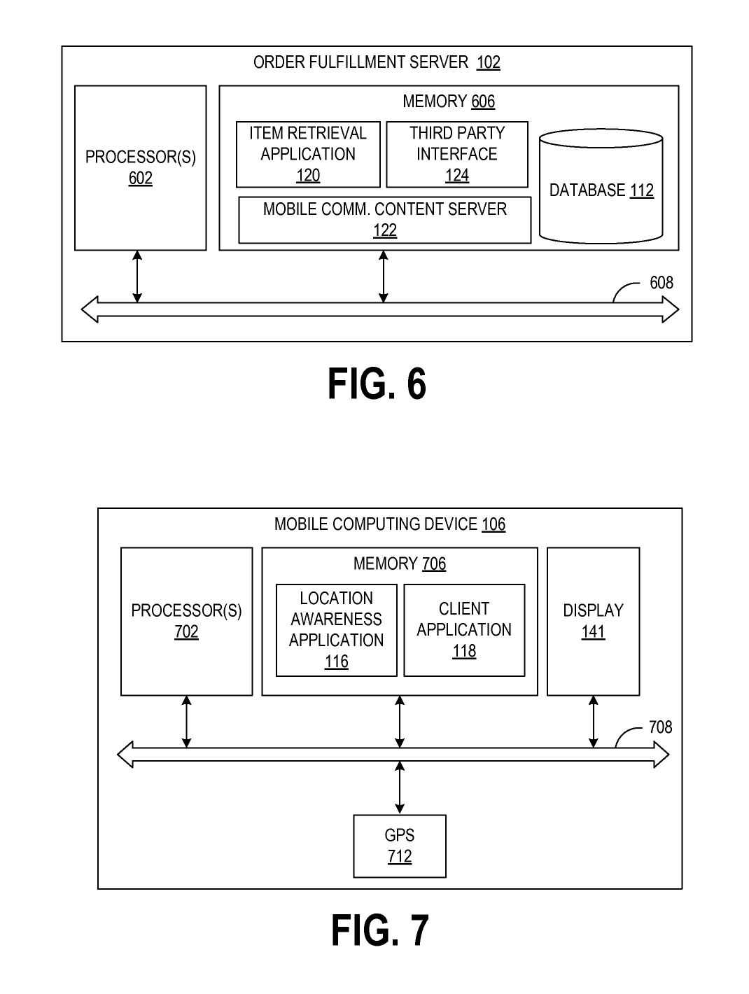

Reference is made to FIG. 6, which is a schematic block diagram of the order fulfillment server 102 according to an embodiment of the present disclosure. The order fulfillment server 102 includes at least one processor 602 and a memory 606, both of which are coupled to a local interface 608. The memory 606 stores both data and components executed by the processor 602. In particular, the memory 606 may store the item retrieval application 120, the third party interface 124, the mobile communication content server 122, and other applications. The database 112 described earlier may also be implemented within the memory 606. In addition, an operating system may be stored in the memory 606 and executable by the processor 602.

With reference to FIG. 7, shown is a schematic block diagram of the mobile computing device 106 configured to receive guidance data 126 (FIG. 1) according to an embodiment of the present disclosure. The mobile computing device 106 includes at least one processor 702 and a memory 706, both of which are coupled to a local interface 708. The mobile computing device 106 also includes a GPS device 712, which may also be coupled to the local interface 708. The memory 706 stores both data and components executable by the processor 702. In particular, the memory 706 may store the location awareness application 116, the client application 118, and other applications. In addition, an operating system may be stored in the memory 706 and executable by the processor 702.

It is understood that there may be other applications that are stored in each of the memories 606/706 and are executable by the respective processors 602/702 as can be appreciated. A number of software components are stored in the respective memories 606/706 and are executable by the processors 602/702. In this respect, the term “executable” means a program file that is in a form that can ultimately be run by a respective processor 602/702.

In the context of this disclosure, a non-transitory computer-readable medium stores programs for use by or in connection with an instruction execution system, apparatus, or device. More specific examples of a computer-readable medium may include by way of example and without limitation: random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Each of the memories 606/706 may include both volatile and nonvolatile memory and data storage components. Thus, each memory 606/706 may comprise, for example, random access memory (RAM), read-only memory (ROM), hard disk drives, solid-state drives, USB flash drives, memory cards accessed via a memory card reader, optical discs accessed via an optical disc drive, and/or other memory components, or a combination of any two or more of these memory components.

In addition, the RAM may comprise, for example, static random access memory (SRAM), dynamic random access memory (DRAM), or magnetic random access memory (M RAM) and other such devices. The ROM may comprise, for example, a programmable read-only memory (PROM), an erasable programmable read-only memory (EPROM), an electrically erasable programmable read-only memory (EEPROM), or other like memory device.

Also, each processor 602/702 may represent multiple processors and each memory 606/706 may represent multiple memories that operate in parallel processing circuits, respectively. In such a case, each local interface 608/708 may be an appropriate network that facilitates communication between any two of the multiple processors, between any processor and any of the multiple memories, or between any two memories, etc.

Although the applications described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 2 shows an example of functionality of various components in the order fulfillment server 102 (FIG. 1). If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 602/702 in a computer system or other system. The machine code may be converted from the source code, etc. If embodied in hardware, each block may represent a circuit or a number of interconnected circuits to implement the specified logical function(s).

Although the flowchart of FIG. 2 shows a specific order of execution, it is understood that the order of execution may differ from that which is depicted. Also, two or more blocks shown in succession in FIG. 2 may be executed concurrently or with partial concurrence. Further, in some embodiments, one or more of the blocks shown in FIG. 2 may be skipped or omitted.

Any application described herein that comprises software or code may be embodied in any non-transitory computer-readable medium for use by or in connection with an instruction execution system such as, for example, a processor in a computer system or other system. In this sense, each may comprise, for example, statements including instructions and declarations that can be fetched from the computer-readable medium and executed by the instruction execution system.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method implemented in at least one computing device for fulfilling an order for an item in a storage facility, comprising:
obtaining an order for the item from a third party order provider;
converting the order to a predetermined format for fulfillment;
generating guidance information based on the converted order and at least one attribute of the item; and
transmitting the guidance information to a wireless computing device for fulfillment of the order by a picker.

2. The method of claim 1, wherein the guidance information is further generated based on a picking method to be applied in retrieving the item.

3. The method of claim 1, wherein the picking method to be applied comprises one of:
picking the item by hand; or
picking the item via a picking machine.

4. The method of claim 1, wherein the order is obtained by the at least one computing device from a third party order provider.

5. The method of claim 1, further comprising appending an identifier to the guidance information.

6. The method of claim 5, further comprising appending a location code, a graphical representation of the item, and an item description to the guidance information.

7. The method of claim 1, further comprising obtaining a confirmation transmitted by the wireless computing device indicating retrieval of the item by the picker.

8. The method of claim 7, further comprising forwarding the confirmation to the third party order provider.

9. The method of claim 1, further comprising obtaining a current location of the wireless computing device, wherein generation of the guidance information is based on the current location of the wireless computing device and a location of the item.

10. The method of claim 9, wherein the guidance information is generated according to a shortest path in the storage facility between the current location of the mobile computing device and the location of the item.

11. The method of claim 1, wherein the guidance information comprises routing data for the storage facility, wherein the routing data is geocentric relative to the item.

12. A system for fulfilling an order for an item in a storage facility, comprising:
a third party interface configured to obtain an order for the item from a third party order provider;
an item retriever configured to obtain data corresponding to the item from a database, wherein the item retriever is further configured to convert the order to a predetermined format for fulfillment according to the data retrieved from the database, and generate guidance information based on the converted order and at least one attribute of the item; and
a content server configured to transmit the guidance information to a wireless computing device for fulfillment of the order by a picker.

13. The system of claim 12, wherein the least one attribute comprises at least one of:
a size of the item;
a quantity specified in the order for the item; or
a storage type of the item.

14. The system of claim 13, wherein the storage type comprises one of:
refrigerated storage; or
unrefrigerated storage.

15. The system of claim 12, wherein the guidance information comprises routing data for the storage facility, wherein the routing data is geocentric relative to the item.

16. The system of claim 12, wherein the data obtained from the database corresponding to the item comprises a layout of the storage facility in which the item is stored.

17. A non-transitory computer-readable medium embodying a program executable in a mobile computing device, comprising:
code that transmits a current location of the mobile computing device to an order fulfillment server;
code that obtains guidance information from the order fulfillment server for picking a plurality of units of an item, wherein the guidance information is generated based on a plurality of orders for the item from at least one third party order provider;
code that encodes for display a user interface based on the guidance information; and
code that transmits an acknowledgement upon retrieving the item.

18. The non-transitory computer-readable medium of claim 17, wherein the guidance information comprises routing information within a storage facility for the item.

19. The non-transitory computer-readable medium of claim 17, wherein the guidance information comprises instructions for distributing the plurality of units of the item among a plurality of orders for the item.

20. The non-transitory computer-readable medium of claim 17, wherein the mobile computing device comprises a tablet computer.
